(19) United States
(12) Patent Application Publication
(10) Pub. No.: US 2006/0063400 A1
(43) Pub. Date: Mar. 23, 2006

(54) Connection structure for server blades

(75) Inventor: Sheng-Yuan Tsai, Taipei City (TW)

Correspondence Address: BACON & THOMAS, PLLC, 625 SLATERS LANE, FOURTH FLOOR, ALEXANDRIA, VA, 22314, US

(73) Assignee: Inventec Corporation, Taipei City (TW)

(21) Appl. No.: 10/947,174

(22) Filed: Sep. 23, 2004

(51) Int. Cl. H01R 12/00

(52) U.S. Cl. 439/74

(57) ABSTRACT

The invention provides a connection structure for installing server blades. Two or more server blades are directly connected via connection interfaces so as to solve the problem of conventional blade server that cannot process any newly joined in signals with the standard backplane of the blade server. Furthermore, since the server signals are usually in high speed and large quantity, transmission by way of backplane also causes wiring difficulty and noise increasing. The connection structure of the invention achieves fast and efficient interchange of massive information that cannot be processed by the backplane.

### BACKGROUND OF THE INVENTION

1. Field of the Invention

The invention generally relates to a connection structure for server blades, and in particular relates to a connection structure for a blade server to adopt installation of two or more server blades.

2. Description of Related Art

FIG. 1 shows a construction of a conventional blade server. The blade server 1 includes a plurality of server blades 2, a backplane (not shown in the drawing) and other components. The server blades 2 are inserted in the cabinet 7 of the blade server 1 and connected with the backplane. The server blades 2 are covered by a plurality of cover plates 3 for protecting the server blades 2 from external force and dust contamination. Generally, each server blade 2 includes a main board 4 connecting to a power supply 5 and a hard disk driver 6. After linking the server blades 2, massive information is transferred and processed through interface in the backplane.

Further referring to FIG. 1, a plurality of server blades 2 are inserted from the front of the cabinet 7 into the blade server 1 along supporting tracks (not shown in the drawing) and connected with the backplane. The blade server 1 thus can operate when signals being exchanged among the server blades 2 by way of the backplane of the server 1 that processes the massive signals. However, when there is a new signal joining in, most backplanes of blade servers 2 are standardized in their specifications that cannot be modified and unable to process the new signal. Furthermore, the interchange signals of the server blades 2 are often in high-speed transmission and of large quantity, if being transferred by way of the backplane, the wirings become more difficult, occupy more space, the impedance is hard to match, and the noise increases.

From the above description, it is apparent that we need a connection structure for convenient exchange of signals among a plurality of server blades. By the connection construction, original server blades can still be used and the replacement expenses can be saved.

### SUMMARY OF THE INVENTION

In view of the above problems, the object of the invention is to provide a connection structure for server blades. It solves the disadvantages of conventional blade server backplane that the backplane is hard to be modified for processing new signals and the wiring of the backplane is difficult. Please note that the server blades do not need to be greatly changed. The connection structure can be used for expansion of server blades, and applicable to many aspects, such as of different signals or circuits.

In order to attain the above object, the invention provides a connection structure for server blades. The server blades are installed in a blade server. The connection structure includes a plurality of server blades each having a cover plate formed with at least a hole, and at least a connection device having at least a connection interface. The server blades are thus connected to each other via the connection interface passing through the hole. The server blades interconnect and directly exchange or process the signals. The system is easy to link up, does not need the connection through a backplane of the blade server, and also relatively saves the cost of replacement of original server blades.

The aforesaid connection device of the server blades is a connector for data access of the server blades. The connector can be directly attached to the server blade, or formed in different structures of interface, such as flat cables, printed circuit boards (PCB), flexible printed circuits (FPC) and so on.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a descriptive view of a conventional blade server;

FIG. 2A is a descriptive view of a connection structure for server blades of the invention;

FIG. 2B is a descriptive view of a cover plate in a server blade of the invention;

FIG. 2C is a partial enlarged view of a connection interface in the connection structure of FIG. 2A;

FIG. 3A is a descriptive view of installation of server blades in a first embodiment of the invention;

FIG. 3B is a descriptive view of connection of server blades in a first embodiment of the invention;

FIG. 4A is a descriptive view of installation of server blades in a second embodiment of the invention;

FIG. 4B is a descriptive view of connection of server blades in a second embodiment of the invention; and

FIGS. 5A to 5E are descriptive views of different connection devices in server blades of the invention.

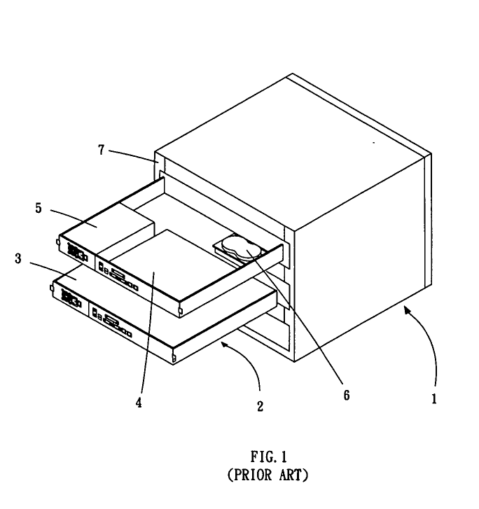

### DESCRIPTION OF THE PREFERRED EMBODIMENTS

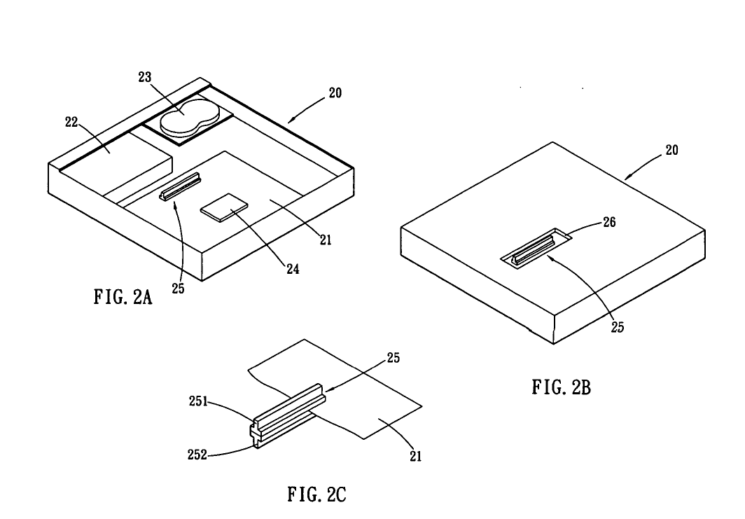

FIG. 2A is a descriptive view of a connection structure for server blades. The server blade 20 includes a main board 21 connected with a power supply 22, a hard disc driver 23, a processor 24 and other peripherals. The processor 24 includes a connection interface 25 for connecting to another system. FIG. 2B is a descriptive view of a cover plate in a server blade of the invention. The server blade 20 includes a cover plate formed with a hole 26 on top of the connection interface 25 of the main board 21. The size of the hole 26 is correspondent to the connection interface 25 of the main board 21. As shown in FIG. 2C, a partial enlarged view of the connection interface 25 shown in FIG. 2A, the connection interface 25 includes an upper connection interface 251 and a lower connection interface 252. The upper connection interface 251 can be connected to the connection interface of another server blade directly, or through flat cables, printed circuit board (PCB), flexible printed circuit (FPC) or other interfaces.

Two preferred embodiments of installation of server blades according to the invention are described below.

### First Embodiment (Vertical Installation)

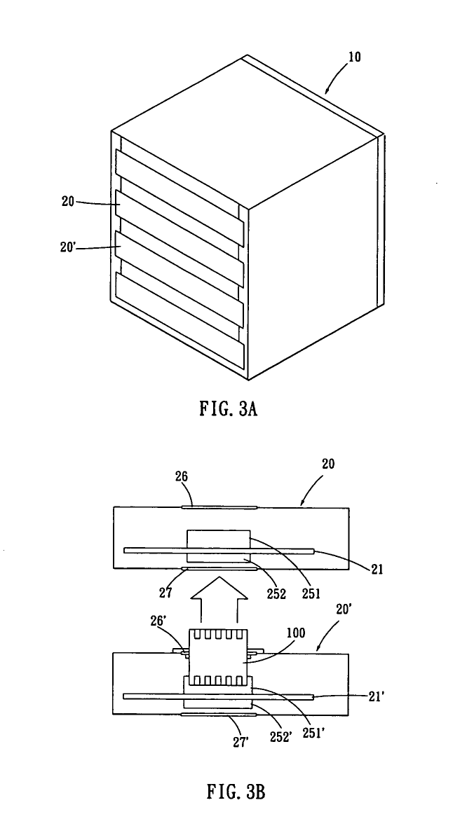

As shown in FIG. 3A, an upper server blade 20 and a lower server blade 20′ are vertically installed in a blade server 10. FIG. 3B shows the connection of server blades in a first embodiment of the invention. The upper server blade 20 and a lower server blade 20′ are connected via a printed circuit board 100. The upper server blade 20 includes an upper hole 26 on an upper cover plate, a lower hole 27 on a lower cover plate, a main board 21, an upper connection interface 251 and a lower connection interface 252. The lower server blade 20′ includes an upper hole 26′ on an upper cover plate, a lower hole 27′ on a lower cover plate, a main board 21′, an upper connection interface 251′ and a lower connection interface 252′.

One end of the printed circuit board 100 is connected with the lower connection interface 252 of the upper server blade 20 through the lower hole 27. Another end of the printed circuit board 100 is connected with the upper connection interface 251′ of the lower server blade 20′ through the upper hole 26′ of the lower server blade 20′. In prior arts, the backplane of the blade server is unable to process a newly joining-in signal because the backplane is standardized and cannot be modified. Through the aforesaid connection, signals form the peripheral devices and main board 21 of the server blade 20 and signals from the peripheral devices and main board 21′ of the server blade 20′ are interchanged and transferred via the printed circuit board 100 passing through the lower hole 27 and the upper hole 26′.

More server blades can be stacked in this way. That is, the upper blade server 20 can be connected with another upper server blade through the upper hole 26; and the lower server blade 20′ can be connected with another lower server blade through the lower hole 27′.

### Second Embodiment (Horizontal then Vertical Installation)

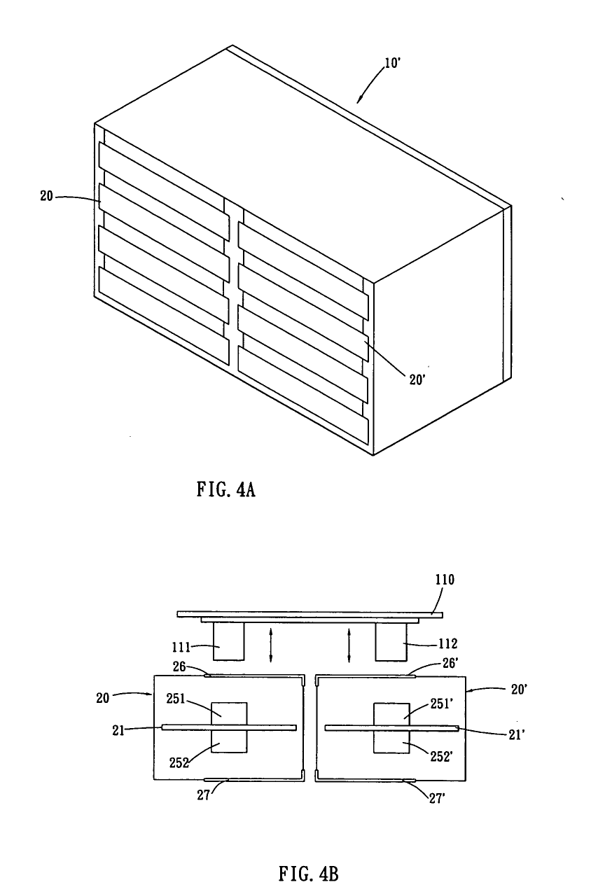

As shown in FIG. 4A, a server blade 20 and a server blade 20′ aside are horizontally installed in a blade server 10′. Then, several layers of the horizontally connected server blades are stacked vertically. The vertical connection of server blades is the same as that in the first embodiment and will not be further described herein. FIG. 4B shows the horizontal connection of server blades in the second embodiment of the invention. The left server blade 20 (defined by the drawing direction) and a right server blade 20′ are connected via a bridgeboard 110. The left server blade 20 includes an upper hole 26 on an upper cover plate, a lower hole 27 on a lower cover plate, a main board 21, and an upper connection interface 251 and a lower connection interface 252. The right server blade 20′ includes an upper hole 26′ on an upper cover plate, a lower hole 27′ on a lower cover plate, a main board 21′, and an upper connection interface 251′ and an lower connection interface 252′. The bridgeboard 110 mainly includes connectors 111, 112, and a signal circuit.

One end of the connector 111 of the bridgeboard 110 is connected with the upper connection interface 251 of the left server blade 20 through the upper hole 26 of the left server blade 20. Another end of connector 112 of the bridgeboard 110 is connected with the upper connection interface 251′ of the right server blade 20′ through the upper hole 26′ of the right server blade 20′. The bridgeboard 110 not only connects with the upper connection interfaces 251, 251′ of the left and right server blades 20, 20′ through the respective upper holes 26, 26′, but also connects with the lower connection interfaces 252, 252′ of the left and right server blades 20, 20′ through the respective lower holes 27, 27′.

In prior arts, the backplane of the blade server is unable to process a newly joining-in signal because the backplane is standardized and cannot be modified. Through the aforesaid connection, signals from the peripheral devices and the main board 21 of the left server blade 20 and signals from the peripheral devices and the main board 21′ of the right server blade 20′ are interchanged and transferred via the upper interfaces 251, 251′ and the bridgeboard 110 passing through the upper holes 26 and 26′.

When using printed circuit board as a connector, a shared circuit can be included and signals such as reset, pwgood, and clk can be provided. Some signal interfaces, such as front side bus (FSB), peripheral component interconnect (PCI), PCI-X and PCIE can also be used.

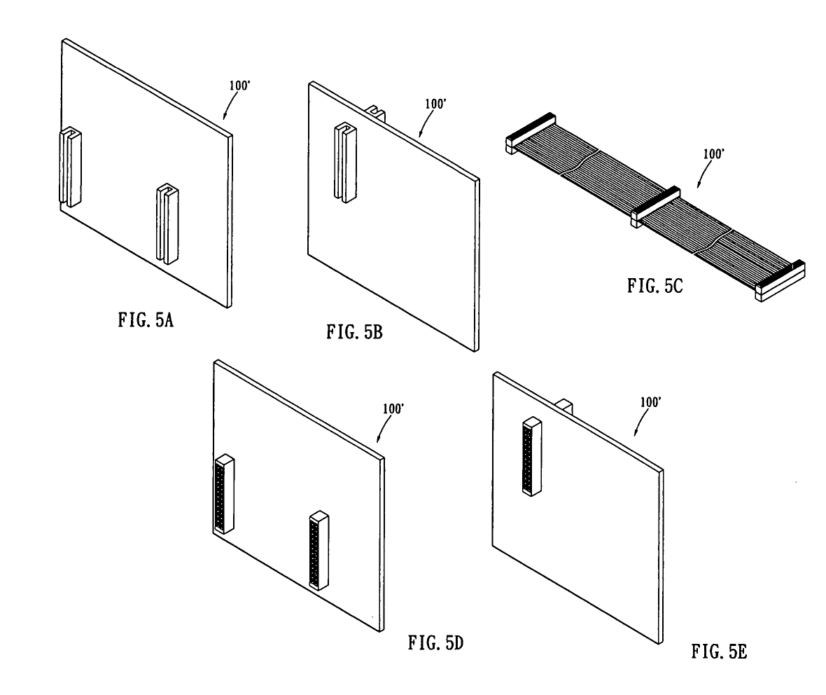

The connection devices in the invention are not limited to aforesaid printed circuit board and bridgeboard. According to the type of the processors 24 and connection interfaces 25 of the server blades 25, different types of connection devices can be used. For example, FIGS. 5A and 5B are printed circuit boards; FIGS. 5C, 5D, and 5E are examples of flat cables or flexible printed circuits (FPC).

More server blades can be stacked in the aforesaid ways. That is, the upper blade servers can be connected horizontally and vertically. Each server blade can also be mounted in a vertical plane and connected to each other in the same manner.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A connection structure for installing server blades in a blade server, comprising:
a plurality of server blades, each server blade having a main board with at least one connection interface disposed thereon, and at least one cover plate having at least one hole defined therein, each said hole being aligned with one of said at least one connection interface; and
at least one connection device connecting one of said connection interfaces of one of said server blades to one of said connection interfaces of another of said server blade.

2. The connection structure for installing server blades according to claim 1 wherein said plurality of server blades are vertically stacked in said blade server.

3. The connection structure for installing server blades according to claim 1 wherein said plurality of server blades includes at least a first set of vertically stacked server blades and a second set of vertically stacked server blades disposed horizontally beside the first set, wherein at least one server blade in said first set and at least one server blade in said second set are horizontally connected by a said at least one connection device.

4. The connection structure for installing server blades according to claim 1 wherein each said server blade further comprises a plurality of peripheral components.

5. The connection structure for installing server blades according to claim 4 wherein said plurality of peripheral components of said server blades further comprise at least a connection interface.

6. The connection structure for installing server blades according to claim 5 wherein said connection interface comprises connectors linking across at least two server blades.

7. The connection structure for installing server blades according to claim 1 wherein said connection device is a printed circuit board.

8. The connection structure for installing server blades according to claim 1 wherein said connection device is a flat cable.

9. The connection structure for installing server blades according to claim 1 wherein said connection device is a flexible printed circuit.
